(19) United States
(12) Patent Application Publication
(10) Pub. No.: US 2018/0225797 A1
(43) Pub. Date: Aug. 9, 2018

(54) TRANSPORTATION SOLUTIONS FOR MULTIPLE DESTINATIONS

(71) Applicants: Mohammad Sulaiman KHORSHEED, Riyadh (SA); Amer Saeed ALHARTHI, Dir'iya (SA)

(72) Inventors: Mohammad Sulaiman KHORSHEED, Riyadh (SA); Amer Saeed ALHARTHI, Dir'iya (SA)

(21) Appl. No.: 15/891,596

(22) Filed: Feb. 8, 2018

Related U.S. Application Data
(60) Provisional application No. 62/456,232, filed on Feb. 8, 2017.

(51) Int. Cl. G06Q 50/30; G08G 1/00; G07C 5/02; G01C 21/34; G01C 21/36; G01C 21/20; H04W 4/02; H04W 4/12

(52) U.S. Cl. CPC G06Q 50/30; G08G 1/20; G07C 5/02; H04W 4/12; G01C 21/3676; G01C 21/20; H04W 4/025; G01C 21/343

(57) ABSTRACT

The present disclosure generally relates to transportation solutions and, more particularly, to systems and methods for transportation solutions for multiple destinations. The transportation solutions include a method for transportation which includes: registering, using at least one computing device, a company which provides transportation services for a transportation system; providing access, using the least one computing device, to users of the transportation system to obtain the transportation services; selecting a transportation vehicle, using the at least one computing device, to transport the users of the transportation system to a destination along a trip path; generating a notification, using the at least one computing device, of a location of the transportation vehicle to the users of the transportation system; and changing, using the at least one computing device, the notification as the transportation vehicle gets closer to the location.

### FIELD OF THE INVENTION

The present disclosure generally relates to transportation solutions and, more particularly, to systems and methods for transportation solutions for multiple destinations.

### BACKGROUND

School bus transportation is widely important. In United States and Canada, there are more than 8 billion trips for students between home and school. In China, more than 2 million school buses transport many of the 150 million primary and middle school students to and from school. Saudi Arabia has more than seven million students studying in more than 35,000 schools, with more than 527,000 teachers. Within the higher education system, there are 1.5 million students. Normally, each university has its own fleet to provide free transportation to some of the students. Additionally, small private transportation companies also extend their transportation services to the teachers.

These statistics, necessitated the establishment of Tatweer Educational Transportation Services Company (TTC), which provides free transportation for both female and male students attending public schools within the country. TTC currently provides free school transportation services to 1,300,000 male and female students across the Kingdom through more than 50,000 trips daily. Other students, faculty members and staff use the small private transportation companies instead for their transportation services.

### SUMMARY

In an aspect of the disclosure, a method for transportation, comprises: registering, using at least one computing device, a company which provides transportation services for a transportation system; providing access, using the least one computing device, to users of the transportation system to obtain the transportation services; selecting a transportation vehicle, using the at least one computing device, to transport the users of the transportation system to a destination along a trip path; generating a notification, using the at least one computing device, of a location of the transportation vehicle to the users of the transportation system; and changing, using the at least one computing device, the notification as the transportation vehicle gets closer to the location.

In an aspect of the disclosure, a computer program product for providing transportation services, the computer program product comprising a computer readable storage medium having program instructions embodied therewith, the program instructions executable by a computing device to cause the computing device to: register a company to provide transportation services for a transportation system; enter information for drivers and passengers of the transportation system; generate a trip plan for a transportation vehicle to transport passengers to a destination along a trip path; and generate a map displaying the trip path of the transportation vehicle from a first stop point in the trip path until the destination.

In an aspect of the disclosure, a system for transportation, comprises: a CPU, a computer readable memory and a computer readable storage medium associated with a computing device; program instructions to register a company which provides transportation services for a transportation system; program instructions to provide access to users of the transportation system to obtain the transportation services; program instructions to select a transportation vehicle to transport the users of the transportation system to a destination along a trip path; program instructions to generate a notification of a location of the transportation vehicle to the users of the transportation system; and program instructions to change the notification as the transportation vehicle gets closer to the location.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for implementing route navigation for multiple destinations in accordance with aspects of the invention.

FIG. 2 shows an illustrative network of computing devices for implementing route navigation for multiple destinations in accordance with aspects of the present invention.

FIG. 3 shows an illustrative computing device for implementing route navigation for multiple destinations in accordance with aspects of the invention.

FIGS. 4A-4C show illustrative models of route navigation for multiple destinations in accordance with aspects of the present invention.

FIGS. 5A-5C show further illustrative models of route navigation for multiple destinations in accordance with aspects of the present invention.

### DETAILED DESCRIPTION

The present disclosure generally relates to transportation solutions and, more particularly, to systems and methods for transportation solutions for multiple destinations. In embodiments, the systems and methods described herein allow for multiple route navigation, where each of one of the routes can include multiple destinations. More particularly, the systems and methods of the present disclosure are directed to generating multiple routes, with each route being between an origin, multiple stops and a final destination, while establishing an estimated time of arrival at each stop. The systems and methods of the present disclosure also allow for a transportation company to partner and interact with other transportation companies to provide transportation services. In this way, multiple transportation companies and passengers can communicate with each other for transportation services.

The transportation solutions provided herein include a website having a front-end, back-end, and an application with pre-defined access for both passengers and drivers. The transportation companies will be able to add their own drivers and passengers from the front end of the website. In embodiments, each transportation company will be able to track its own fleet and monitor driver behavior. As an example, if a transportation vehicle exceeds the speed limit, and a notification can be sent to a fleet manager of the transportation company that the transportation vehicle is exceeding the speed limit. In further embodiments, a main transportation company who has partnered with other transportation companies can monitor any transportation vehicle within the partner fleets.

Drivers of the transportation vehicles are able to login into the application with their pre-defined access. In embodiments, the drivers can receive the schedule for trips, along with the details for each trip. Passengers are also able to use the application with their pre-defined access. Specifically, the systems and methods of the present disclosure aim to alert passengers before the transportation vehicle reaches them. In embodiments, passengers using the application can find the schedule for trips and also receive notification when the transportation vehicle is approaching to a location. In embodiments, as the transportation vehicle begins the trip, each passenger on the transportation vehicle can monitor the trajectory of the transportation vehicle. In this way, each passenger is able to receive a current location of the transportation vehicle on their computing device while traveling. As the transportation vehicle gets closer to its first destination, a first passenger in the list of passengers will receive an alert. In embodiments, the status of the alert changes according to how close the transportation vehicle is to its first destination. In further embodiments, the status of the transportation vehicle can be shared with parents or other people associated with the passengers.

As the first passenger gets onboard, the systems and methods of the present disclosure can update the first passenger's status through various devices. After picking up the first passenger, the next passenger in the list of passengers can be alerted in the same way as the first passenger. In embodiments, if a passenger decides not to get onboard of the transportation vehicle, the passenger can simply cancel and/or skip their trip and their status will be updated for that specific day. The trip path of the transportation vehicle will be updated based on this action of the passenger.

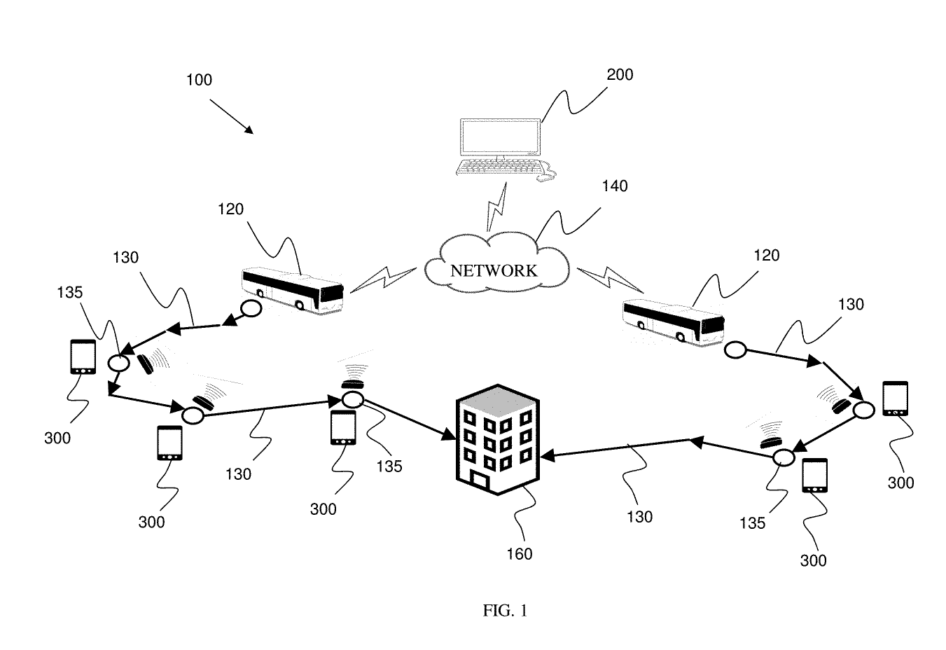

FIG. 1 illustrates a high-level view of the systems and methods provided herein. Specifically, FIG. 1 shows a transportation environment 100 in accordance with aspects of the present disclosure. Computing device 200 of a transportation company generates a trajectory plan, i.e., trip path 130, for each transportation vehicle 120 to pick up passengers at stop points 135 along the trip path 130 to a destination 160. In embodiments, the computing device 200 communicates with the transportation vehicles 120 through the network 140. The transportation vehicle 120 can be a car or a bus, amongst other examples.

The systems and processes described herein aim to alert passengers before the transportation vehicle 120 reaches them. In embodiments, the status of this alert changes according to how close the transportation vehicle 120 is to its first destination. For example, as the transportation vehicle 120 is closer to its first destination, only the first passenger in a passenger list will be receiving an alert through the system. After picking up the first passenger, the system can alert the next passenger in the passenger list in the same way. In embodiments, if a passenger decides not to get onboard, the passenger can simply cancel and/or skip the transportation vehicle 120 and the system will update their status for that specific day only. The trip path 130 of the transportation vehicle 120 can be updated based on this action.

In embodiments, as the transportation vehicle 120 starts the trip path 130, each passenger on that specific transportation vehicle can monitor the transportation vehicle 120 trajectory, i.e., the trip path 130. The passenger can receive the current location of the transportation vehicle 120 on their mobile computing device 300.

The transportation company communicates with their drivers through the network 140, and specifically through an application on mobile computing devices of the drivers. In embodiments, the driver of the transportation vehicle 120 will have a mobile computing device, e.g., a mobile phone or a tablet, for example. Each driver through their mobile computing device will receive trip information through the application from the network 140. In embodiments, each driver is able to login into the application with their pre-defined access to receive trip information. Examples of trip information the driver receives includes scheduling information for each trip, trip path 130, stop points 135 during the trip and passenger information such as a listing of passengers, amongst other information.

Passengers are able to access a website of the systems and processes described herein through the network 140. Specifically, the passengers access the website through an application on the passenger mobile computing device 300, e.g., a mobile phone or a tablet, for example. In further embodiments, passengers which are children may also document their riding the transportation vehicle 120 by using wireless Bluetooth barcode scanners. The passengers will have predefined access to the website. In embodiments, the passengers will find the scheduling of trips and also receive notifications when the transportation vehicle 120 is approaching their location, amongst other information. In embodiments, the application will have allocated screens for the passengers and the drivers.

Passengers who ride the transportation vehicles 120 can be documented in a number of ways. For example, passengers that are children can be documented using near field communication (NFC) tag. Each passenger having an NFC tag can be documented by riding the transportation vehicle 120 by touching their NFC tag with a driver mobile computing device or tab, for example. For adult passengers, the passenger can document their riding the transportation vehicle 120 by using their mobile computing device 300. More specifically, the passenger can document riding the transportation vehicle 120 by using as a button on the application as an optional feature. In further embodiments, when the passenger gets onboard, the system can update the passenger's status either through radio-frequency identification (RFID) tag, a wearable device such as a Bluetooth based bracelet, or the system on the passenger's mobile computing device 300.

Without logging in, a homepage of the website can be used for paid advertisements which can be brought from a database. In further embodiments, a website administrator can receive advertisement requests via the website, with the advertisements being activated after payment. Payment of the advertisements can be out of the system.

The website of the network 140 comprises a front-end and a back-end. In embodiments, the transportation company is able to add their own drivers and passengers from the front-end of the website. The back-end of the website also provides various benefits to the transportation company. As an example, the back-end of the web site allows the company to track its own fleet of transportation vehicles 120 and also monitor driver behavior. From the back-end of the website, a snapshot of how business is performing for the transportation company is provided to a system administrator.

The system administrator is also able to manage all users of the systems and processes described herein, including the transportation company and partner transportation companies and organizations, drivers and passengers, from the back-end of the website. Additionally, the system administrator can receive payment and earnings information for a specific date and/or date range, exporting and viewing data and payments to the transportation company and partner transportation companies, tracking and monitoring of all the fleets of all transportation companies or a specific fleet of a specific transportation company, and trip information. In addition, the system administrator has the ability to create an administrative access level for the tracking and monitoring of selected transportation companies.

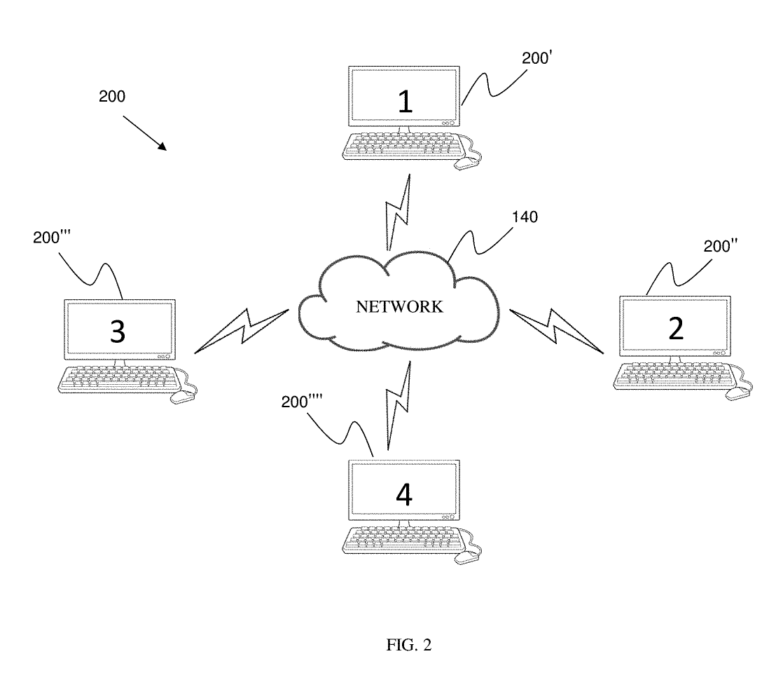

FIG. 2 illustrates an infrastructure 200 in which a main transportation company partners with other transportation companies to provide transportation services. Specifically, infrastructure 200 illustrates an interaction through the network 140 among the various transportation companies. In embodiments, computing device 200′ represents the main transportation company while computing devices 200″, 200′″, 200″″ represent different partner transportation companies. In this way, the main transportation company is capable of monitoring any transportation vehicle 120 within the fleets of the partner transportation companies through the network 140.

The present invention may be embodied as a system, method or computer program product. The present invention may take the form of a hardware embodiment, a software embodiment or a combination of software and hardware. Furthermore, the present invention may take the form of a computer program product embodied in any tangible storage medium of expression having computer-usable program code embodied in computer readable storage medium. The computer readable storage medium is not a transitory signal per se, and is any tangible medium that can contain and store the program for use by or in connection with an instruction execution system, apparatus, or device. For example, the computer readable storage medium can comprise electronic, magnetic, optical, electromagnetic, infrared, and/or semiconductor systems and/or devices. More specific examples (a non-exhaustive list) of the computer readable storage medium include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. Accordingly, the computer readable storage medium may be any tangible medium that can contain or store a program for use by or in connection with an instruction execution system, apparatus, or device of the present invention.

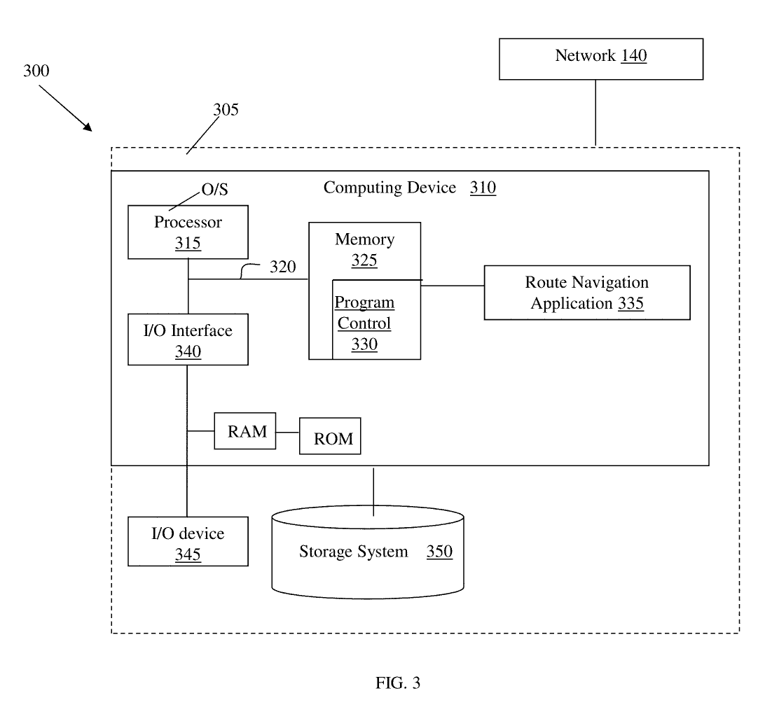

FIG. 3 shows an illustrative mobile computing device 300 for passenger route navigation for multiple destinations. In embodiments, the following description for the passenger mobile computing device 300 can also be applied for the driver's mobile computing device. The mobile computing device 300 includes a computing device 310, which can be a mobile computing device such as a smartphone, tablet computer, personal digital assistant, or similar computing device that includes a mobile operating system, wireless communication antenna, processor, user interface, memory, etc. In embodiments, the mobile computing device 300 can also be representative of a back-end server, provided by a service provider.

The mobile computing device 300 is in communication with the network 140 so that the passenger can access the website from the network 140. Specifically, the computing device 310 interacts with the network 140 through a communication channel. The communication channel can be a wireless channel, among other examples. For example, the communication channel may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the communication channel may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The computing device 310 includes a processor 315 (e.g., CPU), a bus 320, memory 325, and an I/O interface 340. The memory 325 can include a local memory employed during actual execution of program code, bulk storage, and cache memories which provide temporary storage of at least some program code in order to reduce the number of times code must be retrieved from bulk storage during execution. In addition, the computing device 310 includes random access memory (RAM), a read-only memory (ROM), and an operating system (O/S).

The computing device 310 is in communication with external I/O device/resource 345 and storage system 350. For example, I/O device 345 can comprise any device that enables an individual to interact with the computing device 310 (e.g., a user interface such as a touch screen) or any device that enables computing device 310 to communicate with one or more other computing devices using any type of communications link. The external I/O device/resource 345 may be for example, a handset, keyboard etc.

In embodiments, processor 315 executes computer program code (e.g., program control 130), which can be stored in memory 325 and/or storage system 350. While executing the computer program code, the processor 315 can read and/or write data to/from memory 325, storage system 350, and/or I/O interface 340. The bus 320 provides a communications link between each of the components in computing device 310. In accordance with aspects of the invention, program control 330 can also control the route navigation application 335.

The route navigation application 335 allows the user to interact with the network 140, enabling the user to benefit from the systems and processes described herein. Specifically, the passenger is able to use the route navigation application 335 with predefined access. In embodiments, the route navigation application 335 is compatible with various operating systems, including android or IOS, for example. By using the route navigation application 335, passengers will find the scheduling of trips and be able to receive notification when the transportation vehicle 120 is approaching the location 160.

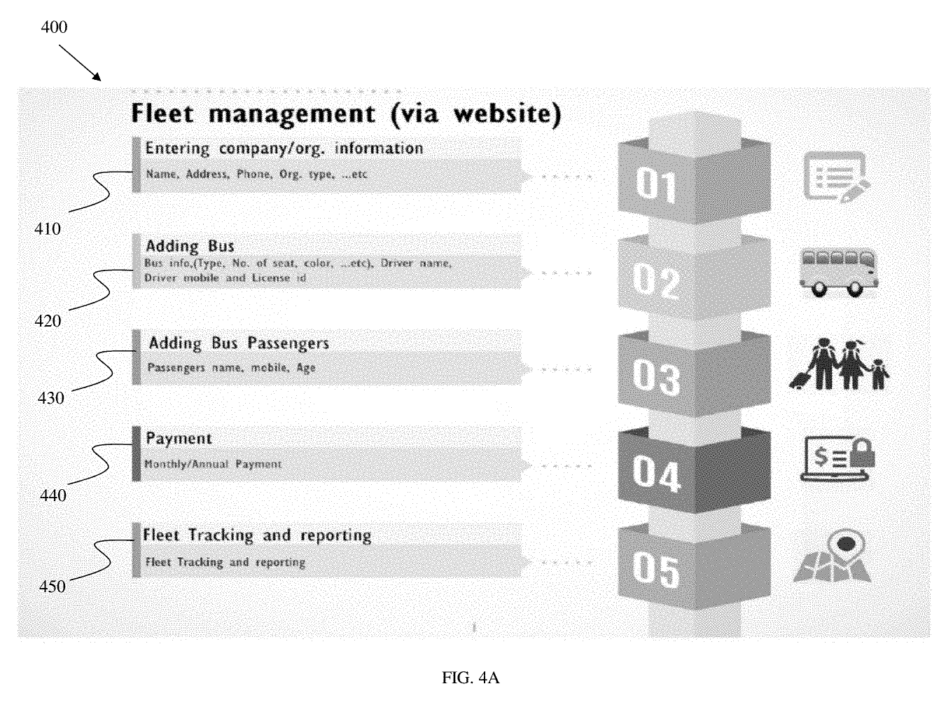

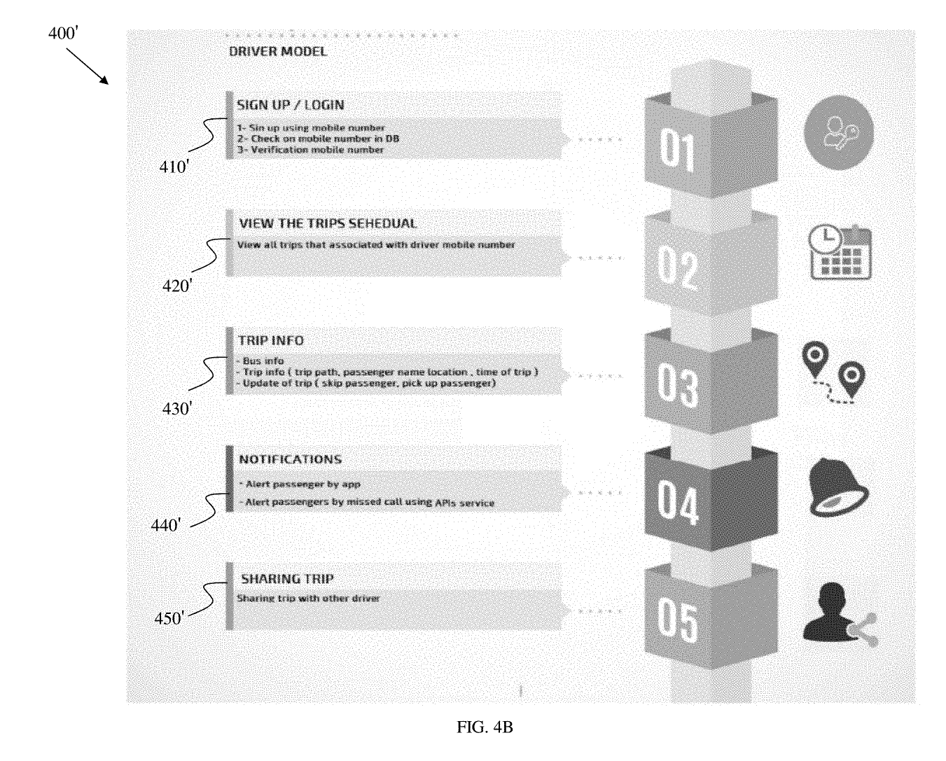

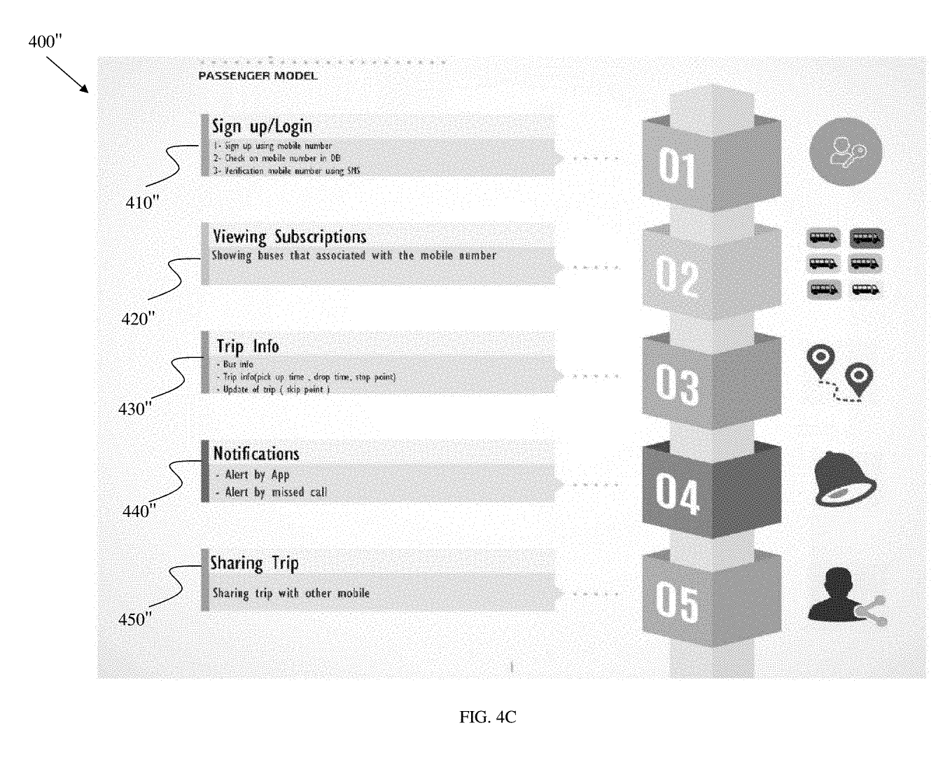

FIGS. 4A-4C illustrate various models of the systems and methods already described herein. Specifically, FIGS. 4A-4C can be implemented on the infrastructures of FIG. 2 or FIG. 3. In FIG. 4A, model 400 illustrates how the transportation company and their partner transportation companies benefit from the systems and methods described herein through the computing device 200. At step 410, the transportation company registers to benefit from the systems and methods described herein. The registration includes completing a registration form comprising company or organization name, organization location such as company address, contact information, organization type, login information and authorization certificate, amongst other registration information. After step 410 is completed, the account associated with the transportation company will an account status of inactive until a solution administrator changes the account status to active. When the status of the account is changed to active, the transportation company can add their trip information, such as trip scheduling, driver information and passenger information, amongst other examples. In embodiments, the transportation companies can add more than one branch to their profile, and can also assign an administrative user for each branch.

For trip scheduling, the transportation company and any partner transportation company can add to the website information concerning the transportation vehicle 120. At step 420, information concerning the transportation vehicle 120 is added. This information includes a selectable vehicle type, a vehicle number, license plate information, license dates, insurance information, number of seats available on the transportation vehicle 120 and color of the transportation vehicle 120, amongst other examples. In embodiments, the transportation vehicle 120 can be selected from the added transportation vehicles.

For the driver information at step 420, the transportation company and any partner transportation company can add to the website driver information such as driver name, driver nationality, license number, license ID information, identification number, age and a phone number, amongst other examples. In embodiments, the driver phone number can be a mobile phone number. This mobile phone number can be used by the driver as a login method into the application, because the mobile phone number does not register for another driver. In this way, the driver phone number is a primary key that can be used as a login method into the application. In further embodiments, a short message service (SMS) invitation can be sent to the mobile phone number so that a driver can register through the application.

At step 430, the transportation company and any partner transportation company can add passenger information to the website. The passenger information includes passenger name, passenger age and passenger phone number, amongst other examples. In embodiments, the passenger phone number can be a mobile phone number. This mobile phone number can be used by the passenger as a login method into the application. In embodiments, an SMS invitation can be sent to the passengers in order to allow the passengers to register through the application. In further embodiments, passenger location can be determined by a passenger using the application when he receives the SMS invitation from the transportation company.

In embodiments, the mobile phone number can be used for more than passenger. For example, a father's mobile phone number can be associated with his three children, who all go to school by one or different transportation vehicles 120. In this way, when the father enters the homepage of the website, the father can find all trips that belong to his children. More specifically, in the homepages of the website, the passenger will find a number of sections based on a number of passengers who are associated with passenger mobile number.

With the trip information at steps 420, 430, the transportation company and any partner transportation company can determine trip dates, e.g., days, trip times, e.g., pick-up and drop-off times, for example. Further, the trip information at steps 420, 430 allow for selection of drivers and passengers, and the selection of additional drivers, if needed. In this way, the transportation company and the partner transportation companies are able to add their drivers and passengers.

At step 440, the transportation company and any partner transportation company can add payment information to the website. In embodiments, the transportation company or organization receives a trial period determined by an administrator of the system from the back-end of the website. After the end of the trial period, the transportation company or organization can choose a suitable payment plan. In embodiments, the payment plan can be annual or monthly, for example. Payment methods for the subscription include credit cards and local payment methods, amongst other examples. When a subscription is finished, the administrator of the system can determine what action should be taken, e.g., disabling passengers and driver login into the application, and disabling the transportation company's access to the website, for example. In this way, the systems and processes described herein allow for the checking of the subscription and the application of any appropriate action that is stored by the system administrator.

At step 450, the transportation company and any partner transportation company can receive a reporting of fleet tracking and monitor information. The fleet tracking and monitoring information includes finding details of all trips, ratings of the drivers and the ability to browse these driver ratings, complaints from passengers and handling them, trip reports and the ability to browse the trip reports, number of passengers who have boarded the transportation vehicle 120, number of passengers who did not board the transportation vehicle 120, speed of the transportation vehicle 120 including a history of the speed of the transportation vehicle 120, the path 130 of the transportation vehicle 120 including a history of the path 130 of the transportation vehicle 120, and the ability to view all passengers who have apologized for the enrollment of any scheduled trips.

In FIG. 4B, model 400′ illustrates how the drivers of the transportation vehicle 120 are able to benefit from the systems and methods described herein. After adding the drivers by the transportation company, each driver will receive an SMS invitation from the system in order to complete registration through the application. At step 410′, the driver will register by signing up and logging into the web site of the network 140. Without logging into the website, the homepage of the website is used for paid advertisements. In embodiments, each driver can register using the mobile number that was added by the transportation company. In this way, the driver's mobile number is verified because the mobile phone number of the driver is being checked within the database of the system. If the driver has not added been by the transportation company, the driver will not be able to complete the registration process. Once the driver is into the system, the driver can update their driver profile from a driver menu. The driver can detect the location 160 by GPS or can determine the location 160 by map, depending on the driver's needs. At step 420′, the driver is able to view the trips schedule. Specifically, the driver is able to view all trips associated with their mobile phone number.

At step 430′, the driver is able to view trip information for each specific trip. In embodiments, the driver will find two sections in the website, with the first section showing driver information such as driver name, mobile phone number, and driver rating, amongst other examples. The first section also shows company/organization information, such as company/organization address, contact information and supervisor name and phone.

Additionally, the first section shows bus information, such as bus number, plate number and additional driver name and number. The second section shows the driver all scheduled trips that associated with his mobile phone number, including a history of the driver's trips. The trip information including trip days, trip times, number of passengers who are registered on the trips, and a map icon. In embodiments, the map icon can display the path 130 of the transportation vehicle 120 from the first stop point of the stop points 135, until a destination, i.e., location 160.

The trip information further includes which passengers to pick up and which passengers to skip. For example, when a passenger skips any specific trip by choosing the trip from their scheduled trips, the driver can receive a notification in the same day that the passenger has skipped the trip before. Further, the path 130 of the transportation vehicle 120 will be updated based on the passenger skipping the trip. In embodiments, the trip information includes passenger comments and driver ratings, which the driver can browse.

At step 440′, the driver is able to receive and send notifications. These notifications are alert tools, in which the driver can set an alarm like a normal mobile phone alarm, but with the additional advantage of enabling the mobile phone to receive alerts from the driver. Further, the transportation company through the driver can alert the passenger by sending a notification with a special notification tone to a passenger, or by API service calls, for example. In embodiments, the notification tone or alarm will gradually rise when the bus approaches the passenger location. In further embodiments, the driver can alert a passenger through the application or by a missed call using APIs services.

Examples of a notification includes when a passenger skips a trip, the driver can receive a notification in the same day that the passenger had skipped before. An additional example of a notification includes receiving a passenger return notification or order when a driver moves from a current stop point 135 to another stop point 135, such as the next stop point 135 after waiting for the passenger for some time and the passenger does not respond. At step 450′, the driver is able to share trip information with another driver. In further embodiments, the system and processes described herein can tag any transportation vehicle 120 which exceeds the speed limit and can send a notification to a fleet manager of the company that the transportation vehicle is exceeding the speed limit.

In FIG. 4C, model 400″ illustrates how passengers of the transportation vehicle 120 are able to benefit from the systems and methods described herein through their mobile computing device 300. After adding the drivers by the transportation company, passengers will receive the SMS invitation from the system in order to complete passenger registration through the application. At step 410″, the passenger can register by signing up and logging into the website of the network 140. Without logging into the website, the homepage of the website is used for paid advertisements. In embodiments, each passenger can register using the mobile phone number that was added by the transportation company. In this way, the passenger's mobile phone number is verified because the mobile phone number of the passenger is being checked within the database of the system. If the passenger has not added been by the transportation company, the passenger will not be able to complete the registration process. Once the passenger is into the system, the passenger can update their passenger profile from the driver menu. The passenger can detect the location 160 by GPS or can determine the location 160 by map, depending on the passenger's needs.

At steps 420″, 430″ the passenger is able to browse the scheduled trips. Specifically, at step 420″, the passenger is able to view the subscriptions. More specifically, the transportation vehicles 120 which are associated with the passenger's mobile phone number are shown to the passenger. At step 430″, the passenger is able to view trip information for each specific trip. Specifically, in homepages of the website, the passenger can find a number of sections based on the number of passengers which are associated with the passenger mobile phone number. Specifically, the home screen of the website for the passenger can be divided into a number of sections based on the number of passengers that are associated with passenger mobile phone number. In this way, each passenger has a section that displays trip information.

The trip information displayed includes passenger name, trip days and trip times such as pick-up and drop-off times for departures and arrivals. The trip information at step 430″ further includes the name, address, phone number, and the supervisor name and phone number of the transportation company/organization. Additionally, the trip information includes a destination name and location link, and bus information. The bus information includes bus number, plate number, and additional driver name and number. The trip information further includes driver information, which includes driver name, driver mobile phone number and driver rating. In embodiments, the trip information at step 430″ includes the details/history of this trip.

Concerning the trip itself, when the driver of the bus first starts the trip, each passenger who will be riding that specific bus can monitor the bus trajectory. The passenger will be receiving the current location of the bus on the application on their mobile computing device 300 and the expected time of arrival (ETA). The passenger can rate the driver and service after drop off. In embodiments, the bus trajectory is divided into smaller slots, with the ETA being calculated for each slot. The system continuously records actual arrival time to each bus stop, i.e, the destination 160. This accumulative knowledge effectively contributes to the calculation of the new ETA next day.

At step 440″, the passenger is able to receive and send notifications. These notifications are alert tools, in which the passenger can set an alarm like a normal mobile phone alarm, but with the additional advantage of enabling the mobile phone to receive alerts from the driver. In embodiments, the driver can alert the passenger by sending the notification with a special notification tone to the passenger or by a missed call through API service calls, for example. Specifically, the passenger can receive the notifications on their mobile computing device 300 by alert through the application and/or alert by missed call. In embodiments, the notification tone or alarm will gradually rise when the bus approaches the passenger location.

The passenger can receive notifications when the bus approaches to the passenger location. In embodiments, the notification tone or alarm will gradually rise when the bus approaches the passenger location. In embodiments, the passenger can send return a notification or an order to the driver when the driver moves from the current stop point to the next stop point after waiting for the passenger for a period of time and the passenger does not respond.

The passenger can skip any specific trip by choosing the trip from their scheduled trips and clicking on the “skip this trip” feature. If the passenger skips the trip, the driver can receive a notification for the passenger's action in the same day that the passenger had skipped before. If the passenger skips the trip, the path of transportation vehicle 120 will be updated based on this action of the passenger skipping the trip. Additionally, the passenger can send a notification to the transportation company. In embodiments, the passenger can send a complaint or notice to the management of the transportation company or organization about any problem related to the trips or the driver.

At step 450″, the passenger is able to share trip information with another mobile computing device. Specifically, the passenger is able to share trip information with another user of the system or a passenger. In embodiments, if the passenger desires to share the selected trip, the passenger will enter the mobile number of the other passenger that the passenger wants to share the trip with. After entering the mobile phone number of the other passenger, the system will give authority to this mobile phone number for registration and send an invitation by SMS to the registered mobile phone number of the other passenger.

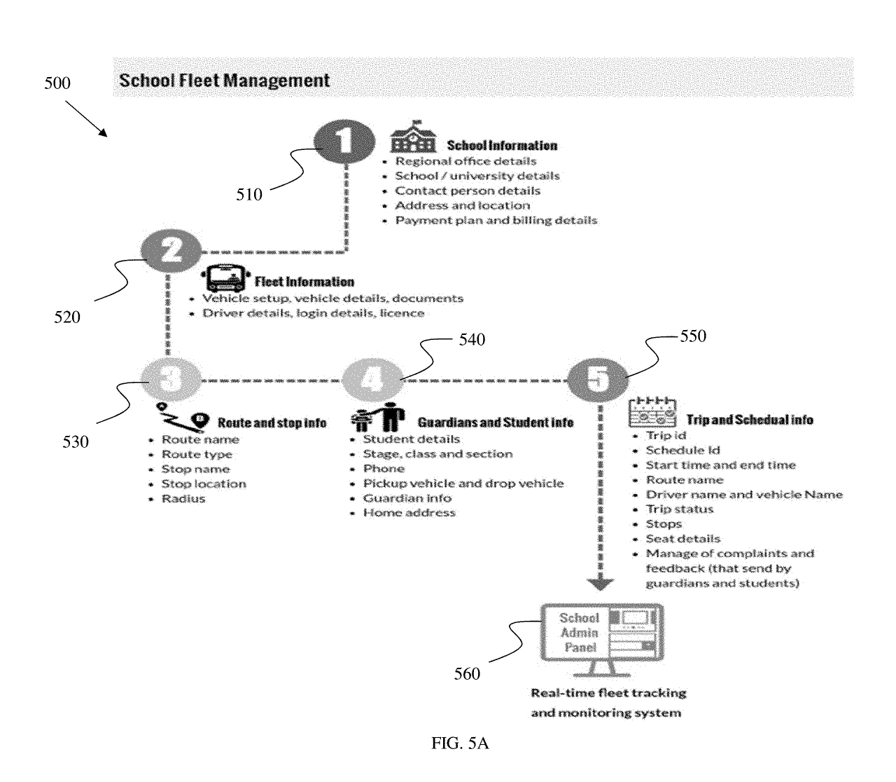

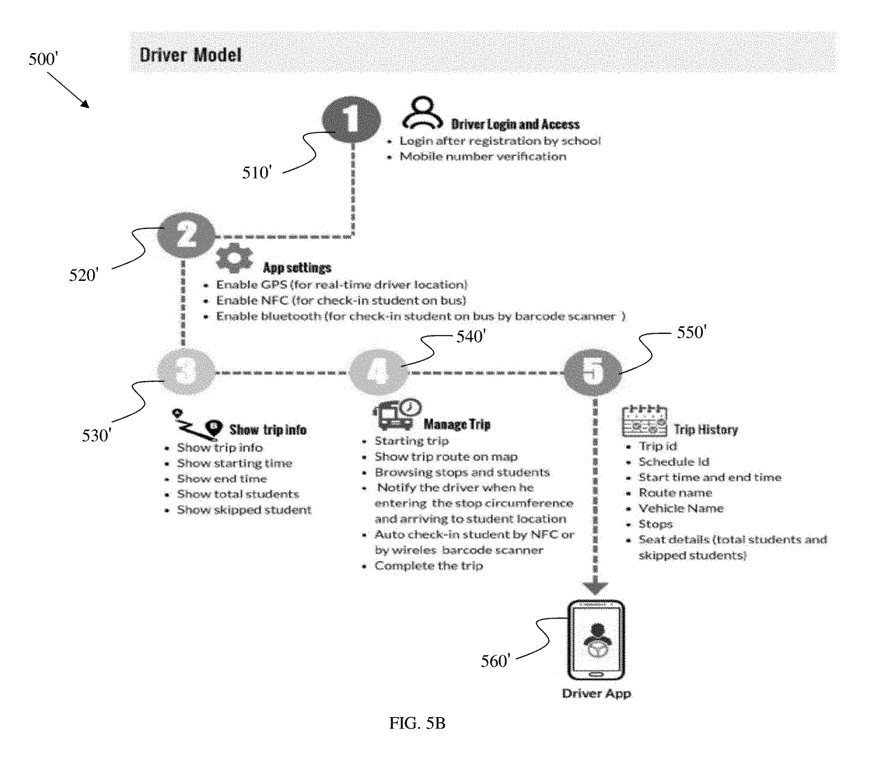

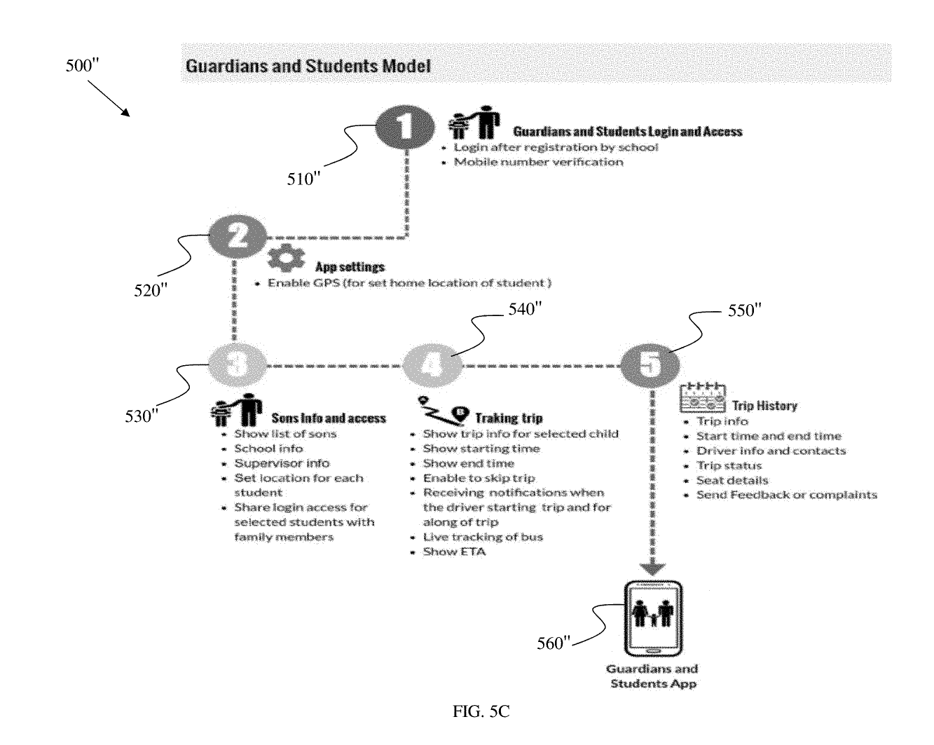

FIGS. 5A-5C illustrate further models of the systems and methods already described herein. Specifically, FIGS. 5A-5C can be implemented on the infrastructures of FIG. 2 or FIG. 3. In FIG. 5A, model 500 illustrates how the transportation company and their partner transportation companies further benefit from the systems and methods described herein through the computing device 200 by being able to perform school fleet management. At step 510, the transportation company and/or their partner transportation companies are able to enter and view specific information concerning the destination 160. For example, the destination 160 can be a school and the transportation company will be able to enter and view information concerning the school. Examples of the school information include regional office details of the transportation company which provides the transportation services to the school/university, details about the school/university, details for the contact person at the school/university, an address and location of the school/university and payment plan and billing details for the school/university.

In step 520, the transportation company and/or any of their partner transportation companies are able to enter and view fleet information of the fleet of transportation vehicles 120 which are providing transportation services to the school/university. Examples of the fleet information include information for the transportation vehicles 120 and for the drivers of the transportation vehicles 120. The information concerning the transportation vehicle 120 includes vehicle setup, vehicle details and documents, amongst other examples. The information for the drivers includes driver details, login details and licenses, amongst other examples.

In step 530, the transportation company and/or any of their partner transportation companies are able to enter and view route and stop point information for the transportation vehicles 120. Examples of the route and stop point information include route name, route type, stop name, stop location and radius of the trip, amongst other examples.

In step 540, the transportation company and/or any of their partner transportation companies are able to enter and view the guardian(s) and student information and any other individual for the passengers riding the transportation vehicles 120. Examples of the guardian and student information include details about the student, stage, class and section of the student, phone number of the student, information concerning the pickup vehicle and the drop-off vehicle which the student is taking, information for the guardian of the student and a home address for both the student and the guardian.

In step 550, the transportation company and/or any of their partner transportation companies are able to enter and view the trip history of each transportation vehicle 120. Examples of the information in the trip history includes trip identification (Id), schedule Id, start time and end time for each trip of the transportation vehicle 120, route name, driver name and vehicle name, trip status, stop points 135, seat details of the passengers, and information concerning complaints and feedback of the guardians and students, and the ability to be able to manage the complaints and feedback through the systems and methods already described herein. In step 560, the transportation company and any of their partner transportation companies are able to view in real-time the fleet tracking and monitoring of the transportation vehicles 120 through the computing device 200 of the transportation company.

In FIG. 5B, model 500′ illustrates how the driver of the transportation vehicle 120 can further benefit from the systems and methods described herein through their mobile computing device. At step 510′, each driver of the transportation vehicles 120 are able to login into the website of after registration by the school. Further, at step 510′, the driver's phone is able to be verified.

At step 520′, the driver can enable GPS on their mobile computing device to allow for real-time driver location. Additionally, the driver can enable NFC on their mobile computing device to allow for the checking-in of students on the transportation vehicle 120. In addition, the driver can enable Bluetooth on their mobile computing device to allow for the checking-in of students on the transportation vehicle 120 by barcode scanner.

At step 530′, the driver can view trip information associated with the transportation vehicle 120 the driver is driving. Examples of trip information includes showing the start time of the trip, showing the end time of the trip, show the total number of passengers riding the transportation vehicle 120 and also showing the number of passengers who skipped the trip.

At step 540′, the driver can view and enter information for the management of the trip. For examples, the driver can initiate starting of the trip, the driver can show the trip route on a map, the driver can browse the stop points 135 and the passengers which are riding and will be riding the transportation vehicle 120. Further, step 540′ allows the driver to be notified when the driver enters a stop circumference and arrives at a student location. Additionally, step 540′ allows for the auto-checking of passengers by NFC or by wireless barcode scanner. In addition, step 540′ allows for the management of the completion of the trip.

In step 550′, the driver is able to view the trip history of the transportation vehicle 120. Examples of the trip history information include trip Id, schedule Id, starting times and ending times of the trip, route name, vehicle name, stop points 135, and seat details which include total passengers and skipped passengers. Step 560′ shows that the driver is able to perform all these functions through the application on their mobile computing device.

In FIG. 5C, model 500″ illustrates how the guardians and students and any other individual further benefit from the systems and methods described herein through the computing device 300. In step 510″, the guardian and the student are able to login after registration by the school. Step 510″ further allows the verification of the phone number of the guardian, and if different from the guardian, the phone number of the student. At step 520″, both the guardian and the student can enable GPS on the mobile computing device 300 to set the home location of the student.

Step 530″ shows the information that is able to be viewed and entered by the guardians and the students and any other designated individual. The information at step 530″ includes showing a list of sons, school information, supervisor information, the set location for each student and the ability to share login access for selected students with family members. Step 540″ shows the information that is able to be viewed and entered by the guardians and the students. The information at step 540″ includes showing trip information for the selected student, showing a start time of the trip, showing an end time for the trip, enabling the student to skip the trip, receiving notifications when the driver starts the trip and for along the trip, live tracking of the transportation vehicle 120, and showing the ETA of the transportation vehicle 120.

Step 550″ the information that is able to be viewed and entered by the guardians and the students and any other designated individual. The information at step 550″ includes trip information, the starting times and ending times of the trip, trip status, seat details and the ability to send feedback or complaints. Step 560″ shows that the guardians and the students are able to perform all these functions through the application on their mobile computing device 300.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for transportation, comprising:
registering, using at least one computing device, a company which provides transportation services for a transportation system;
providing access, using the least one computing device, to users of the transportation system to obtain the transportation services;
selecting a transportation vehicle, using the at least one computing device, to transport the users of the transportation system to a destination along a trip path;
generating a notification, using the at least one computing device, of a location of the transportation vehicle to the users of the transportation system; and
changing, using the at least one computing device, the notification as the transportation vehicle gets closer to the location.

2. The method of claim 1, wherein the providing the access to the users comprises:
entering, using the least one computing device, driver information for a driver of the transportation vehicle; and
entering, using the least one computing device, passenger information for a passenger of the transportation vehicle.

3. The method of claim 2, wherein the entering the driver and passenger information comprises entering a mobile phone number of a driver mobile computing device and a passenger mobile computing device.

4. The method of claim 3, wherein the mobile phone number can be used for more than passenger.

5. The method of claim 4, wherein the trip path of the transportation vehicle is updated when the passenger skips the transportation vehicle.

6. The method of claim 5, wherein the generating the notification comprises a missed phone call to the mobile phone number using API services.

7. The method of claim 6, wherein the changing the notification comprises sending a notification with a special tone to the mobile phone number.

8. The method of claim 7, wherein a first passenger in a passenger list receives the notification while other passengers in the passenger list do not.

9. The method of claim 8, further comprising receiving, using the at least one computing device, an update that the passenger has boarded the transportation vehicle.

10. The method of claim 9, wherein the at least one computing device receives the update from an RFID tag, a wearable device or the passenger's mobile computing device.

11. The method of claim 10, further comprising providing, using the at least one computing device, a status of the transportation vehicle to a relative of the passenger.

12. A computer program product for providing transportation services, the computer program product comprising a computer readable storage medium having program instructions embodied therewith, the program instructions executable by a computing device to cause the computing device to:
register a company to provide transportation services for a transportation system;
enter information for drivers and passengers of the transportation system;
generate a trip plan for a transportation vehicle to transport passengers to a destination along a trip path; and
generate a map displaying the trip path of the transportation vehicle from a first stop point in the trip path until the destination.

13. The computer program product of claim 12, wherein the information for the drivers comprises a different mobile phone number registered for each driver.

14. The computer program product of claim 13, wherein the information for the passengers includes a single phone number for the passengers.

15. The computer program product of claim 14, further comprising:
generating an alert to the passengers through the single phone number as the transportation vehicle approaches their location; and
changing the alert from a phone call to a tone.

16. The computer program product of claim 15, wherein the phone call is through API services.

17. The computer program product of claim 15, wherein the notification tone gradually rises as the transportation vehicle approaches a passenger location.

18. A system for transportation, comprising:
a CPU, a computer readable memory and a computer readable storage medium associated with a computing device;
program instructions to register a company which provides transportation services for a transportation system;
program instructions to provide access to users of the transportation system to obtain the transportation services;
program instructions to select a transportation vehicle to transport the users of the transportation system to a destination along a trip path;
program instructions to generate a notification of a location of the transportation vehicle to the users of the transportation system; and
program instructions to change the notification as the transportation vehicle gets closer to the location.

19. The system of claim 18, further comprising program instructions to receive a notification that the transportation vehicle is exceeding a speed limit.

20. The system of claim 18, wherein the change in notification comprises a change in tone as the transportation vehicle approaches a user location.
